(19) United States
(12) Patent Application Publication
(10) Pub. No.: US 2025/0348043 A1
(43) Pub. Date: Nov. 13, 2025

(54) FLOAT-DISCRETE DIFFERENTIAL DYNAMIC PROGRAMMING SUCCESSIVE APPROXIMATION METHOD FOR CASCADE RESERVOIR GROUP SCHEDULING

(71) Applicant: WUHAN UNIVERSITY, Wuhan City (CN)

(72) Inventors: Xueshan AI, Wuhan City (CN); Longqing ZHAO, Wuhan City (CN); Fengshuo LIU, Wuhan City (CN); Yangxin YU, Wuhan City (CN); Xiaoke ZHANG, Wuhan City (CN); Yaoqun CUI, Wuhan City (CN); Zihang LUO, Wuhan City (CN); Xuanyu SHI, Wuhan City (CN)

(73) Assignee: WUHAN UNIVERSITY, Wuhan City, HB (CN)

(21) Appl. No.: 18/736,597

(22) Filed: Jun. 7, 2024

(30) Foreign Application Priority Data
May 8, 2024 (CN) 2024105678541

(51) Int. Cl. G05B 11/06; E02B 9/02

(52) U.S. Cl. CPC G05B 11/06; E02B 9/02

(57) ABSTRACT

The invention provides a float-discrete differential dynamic programming successive approximation method for cascade reservoir group scheduling, comprising the following steps: water levels of cascade reservoir group are raised from small to large according to water surface areas of reservoirs; the cascade reservoir group generates electricity after raising the water level according to incoming water; at the end of calculation period, and initial water level trajectory is obtained when the raised water level of the cascade reservoir group falls back to the set water level; based on the initial water level trajectory obtained, discrete differential dynamic programming calculation of each reservoir is carried out from upstream to downstream with the goal of maximizing the cascade total power generation, and the improved water level trajectory of each cascade reservoir is obtained; taking the improved water level trajectory of each cascade reservoir as the initial trajectory, and the iterative optimization is carried out.

### TECHNICAL FIELD

The invention relates to the field of reservoir scheduling technology, in particular to a float-discrete differential dynamic programming successive approximation method for cascade reservoir group scheduling.

### BACKGROUND ART

The essence of the optimal operation of cascade hydropower stations is the establishment and solution of the model. In terms of model establishment, the optimal scheduling model to maximize power generation is the basic guarantee for the full utilization of cascade hydropower resources in the river basin for the medium and long-term scheduling of cascade hydropower stations. In terms of the solution of the model, the most commonly used solution methods are dynamic programming successive approximation (DPSA) algorithm and intelligent algorithm.

The DPSA algorithm is based on dynamic programming, the dynamic programming calculation is carried out one by one from upstream to downstream, and the initial trajectory is obtained, then the operation trajectories of other reservoirs are fixed, and the dynamic programming method is used to calculate one by one from top to bottom, at this time, the benefit value is the total benefit of the cascade, this cycle is repeated until the operation trajectory of each reservoir is unchanged or the total benefit of the cascade converges. The intelligent algorithm is mainly based on genetic algorithm and particle swarm optimization and uses massive computing to obtain better target values.

The DPSA algorithm can obtain a better optimal solution, but each reservoir is calculated several times by the dynamic programming method, the calculation workload is large and the calculation time is long. The intelligent algorithm is easy to fall into the local optimal solution, and the obtained solution is unstable, and it is difficult to obtain the global optimal solution. These solving methods rely too much on mathematical methods and do not take into account the change law of cascade reservoirs' water energy, so a large number of calculations are useless. Based on this, the invention proposes a float-discrete differential dynamic programming successive approximation method for cascade reservoir group scheduling and proposes new ideas and methods for solving the optimal scheduling model of cascade reservoir groups.

### SUMMARY

The purpose of the invention is to provide a float-discrete differential dynamic programming successive approximation method for cascade reservoir group scheduling, which makes full use of the relationship between the output of cascade hydropower stations and the water head, reduces the invalid calculation workload, and improves the calculation efficiency.

In order to achieve the above purpose, the invention provides a float-discrete differential dynamic programming successive approximation method for cascade reservoir group scheduling, comprising the following steps:
S1, raising a water level of a cascade reservoir group from small to large according to water surface areas of reservoirs;
S2, generating electricity by the cascade reservoir group after raising the water level according to incoming water;
S3, at an end of a calculation period, and obtaining an initial water level trajectory when a raised water level of the cascade reservoir group falls back to a set water level;
S4, based on the initial water level trajectory obtained, carrying out a discrete differential dynamic programming calculation of each reservoir from upstream to downstream to maximize a cascade total power generation, and obtaining an improved water level trajectory of each cascade reservoir;
S5, taking the improved water level trajectory of each cascade reservoir as an initial trajectory, and carrying out an iterative optimization according to S4 until the water level trajectory of each cascade reservoir is unchanged or a total power generation value during a cascade calculation period is unchanged.

Preferably, in S1, raising the water level of the cascade reservoir group from small to large according to the water surface areas of the reservoirs, the specific operation is as follows:
S101, obtaining the water surface area of each reservoir from a given initial water level of each reservoir according to a water level area relationship curve of each reservoir;
S102, at a beginning of the calculation period, discharging water and generating electricity by a last reservoir according to requirements of ecological flow, generating electricity by other reservoirs according to an expected output power generation mode, and adjusting a water storage capacity of each reservoir so that the reservoir with the smallest water surface area is stored first until it is full;
S103, according to an order of water surface area from small to large, storing water until the reservoirs are full;

Preferably, in S3, obtaining the initial water level trajectory when the raised water level of the cascade reservoir group falls back to the set water level, the specific operation is as follows:
S301, starting from the water level given at an end of a last period of a first reservoir and according to an expected output, reversely generating electricity according to a predicted natural inflow, and calculating an initial water level of the period;
S302, based on the initial water level of the period calculated by S301, reversely generating electricity according to the expected output, and calculating an initial water level of the previous period;
S303, repeating S302 until an initial water level of a certain period exceeds the water level calculated by S1, at this time, recalculating an output value of this period according to the water level calculated by S1, obtaining a water level change process of a first hydropower station combined with the water level calculated by S1;
S304, repeating S301-S303 for the cascade reservoirs from upstream to downstream until a calculation of a most downstream level reservoir is completed, and obtaining the initial water level trajectory of each cascade reservoir.

In S4, based on the initial water level trajectory obtained, carrying out the discrete differential dynamic programming calculation of each reservoir from upstream to downstream, and obtaining the improved water level trajectory of each cascade reservoir, the specific operation is as follows:
forming a corridor by taking 2-3 discrete points from the upper and lower water level values of the initial water level trajectory of the first reservoir at the end of each period (except the last period) according to a certain step length, and fixing initial water level trajectories of other reservoirs to maximize the cascade total power generation during the calculation period, carrying out the dynamic programming calculation in the corridor to obtain a new water level trajectory, then, re-selecting the corridors based on the new water level trajectory for dynamic programming calculation until the new water level trajectory is stable, and then, carrying out the dynamic programming calculation after reducing a discrete step size until the discrete step size meets a preset accuracy and the water level trajectory is stable;
carrying out calculations of the second and third reservoirs respectively according to the above steps until the calculation of the last reservoir is completed, and obtaining the improved water level trajectory of each cascade reservoir;
based on the improved water level trajectories of cascade reservoirs, repeating the above process until the improved water level trajectories of cascade reservoirs are no longer changed.

Preferably, an maximum objective function of the cascade total power generation is as follows:

$$max E = {\sum }_{i = 1}^{I} {\sum }_{t = 1}^{T} {N}_{it} Δ {T}_{t} = {\sum }_{i = 1}^{I} {\sum }_{t = 1}^{T} {K}_{it} {Q}_{it} {H}_{it} Δ {T}_{t}$$

where E denotes a cascade power generation, kWh; I denotes a number of hydropower stations; i denotes a serial number of the hydropower stations, i∈[1, I]; T denotes a number of scheduling periods; t denotes a serial number of the scheduling periods, t∈[1, T]; Kᵢₜ denotes an output coefficient of a i-th hydropower station in a t-th period; Nᵢₜ denotes an average output of the i-th hydropower station in the t-th period, kW; Qᵢₜ denotes an average power generation flow of the i-th hydropower station in the t-th period, m³/s; Hᵢₜ denotes an average power generation water head of the i-th hydropower station in the t-th period, m; ΔTₜ denotes a length of the t-th period, h.

Preferably, a scheduling model of cascade hydropower stations to maximize the total power generation meets a following constraint:
reservoir water level constraint:

$${Z}_{min}^{i} ( t + 1 ) \leq {Z}_{i} ( t + 1 ) \leq {Z}_{max}^{i} ( t + 1 )$$

where Zᵢ(t+1) denotes a reservoir water level of a i-th reservoir at an end of the t-th period, m;

$${Z}_{min}^{i} ( t + 1 )$$

denotes a lower limit of the reservoir water level of the i-th reservoir at the end of the t-th period, m;

$${Z}_{max}^{i} ( t + 1 )$$

denotes an upper limit of the reservoir water level of the i-th reservoir at the end of the t-th period, m;
water balance constraint:

$${V}_{i} ( t + 1 ) - {V}_{i} ( t ) = ( {Q}_{in}^{i} ( t ) - {Q}_{out}^{i} ( t ) - {Q}_{loss}^{i} ( t ) ) Δ t$$

where Vᵢ(t+1) and Vᵢ(t) denote the storage capacities of the i-th reservoir at the end and a beginning of the t-th period, m³;

$${Q}_{i n}^{i} ( t )$$

denotes an inflow of the i-th reservoir at the beginning of the t-th period, m³/s;

$${Q}_{o u t}^{i} ( t )$$

denotes an outflow of the i-th reservoir at the beginning of the t-th period, m³/s;

$${Q}_{loss}^{i} ( t )$$

denotes a loss now or the i-th reservoir at the beginning of the t-th period, m³/s;
output constraint of hydropower station:

$${P}_{min}^{i} ( t ) \leq {P}_{i} ( t ) \leq {P}_{max}^{i} ( t )$$

where Pᵢ(t) denotes an output of the i-th reservoir in the t-th period, kW;

$${P}_{min}^{i} ( t )$$

denotes a lower limit of the output of the i-th reservoir in the t-th period, kw,

$${P}_{max}^{i} ( t )$$

denotes an upper limit of the output of the i-th reservoir in the t-th period, kW;
discharge flow constraint:

$${Q}_{min}^{i} ( t ) \leq {Q}_{out}^{i} ( t ) + {Q}_{loss}^{i} ( t ) \leq {Q}_{max}^{i} ( t )$$

where

$${Q}_{min}^{i} ( t )$$

denotes a lower or the outflow of the i-th reservoir in the t-th period, it is controlled by an ecological flow water demand or a power generation flow corresponding to a minimum output, m³/s;

$${Q}_{max}^{i} ( t )$$

denotes a maximum discharge of the i-th reservoir in the t-th period, it is controlled by a discharge capacity, m³/s;

$${Q}_{in}^{i + 1} ( t ) = {Q}_{out}^{i} ( t ) + {Q}_{loss}^{i} ( t ) + {Q}_{qj}^{i + 1} ( t )$$

where

$${Q}_{in}^{i + 1} ( t )$$

denotes the inflow of the t-th period of an i+1-th reservoir, m³/s;

$${Q}_{qj}^{i + 1} ( t )$$

denotes an interval flow of the i-th reservoir and the i+1-th reservoir in the t-th period, m³/s;
end water level constraint:

$${Z}_{i} ( T + 1 ) = {Z}_{i}^{end}$$

where Zᵢ(T+1) denotes the end water level of the i-th reservoir in the T-th period, m;

$${Z}_{i}^{end}$$

denotes the water level at an end of the calculation period of the i-th reservoir, m;
non-negative constraints: all variables are non-negative.

Therefore, the invention adopts the above-mentioned float-discrete differential dynamic programming successive approximation method for cascade reservoir group scheduling, which makes full use of the relationship between the output of cascade hydropower stations and the water head, reduces the invalid calculation workload, and improves the calculation efficiency.

### BRIEF DESCRIPTION OF THE DRAWINGS

FIG. 1 is a flow chart of the float-discrete differential dynamic programming successive approximation method for cascade reservoir group scheduling.

FIG. 2 is a flow chart of raising the water level of the cascade reservoir group;

FIG. 3 is a flow chart for obtaining the initial water level trajectory of each cascade reservoir.

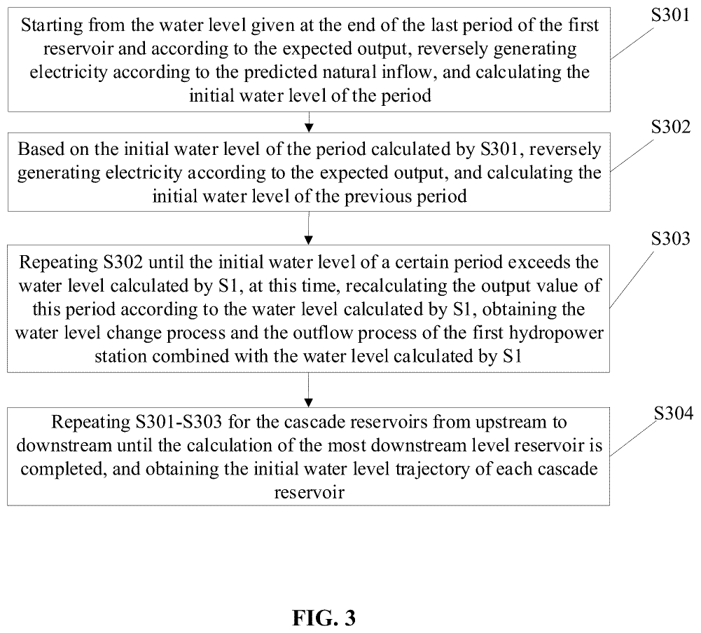

### DETAILED DESCRIPTION OF THE EMBODIMENTS

The following is a further explanation of the technical solution of the invention through drawings and an embodiment.

Unless otherwise defined, the technical terms or scientific terms used in the invention should be understood by people with general skills in the field to which the invention belongs.

### Embodiment 1

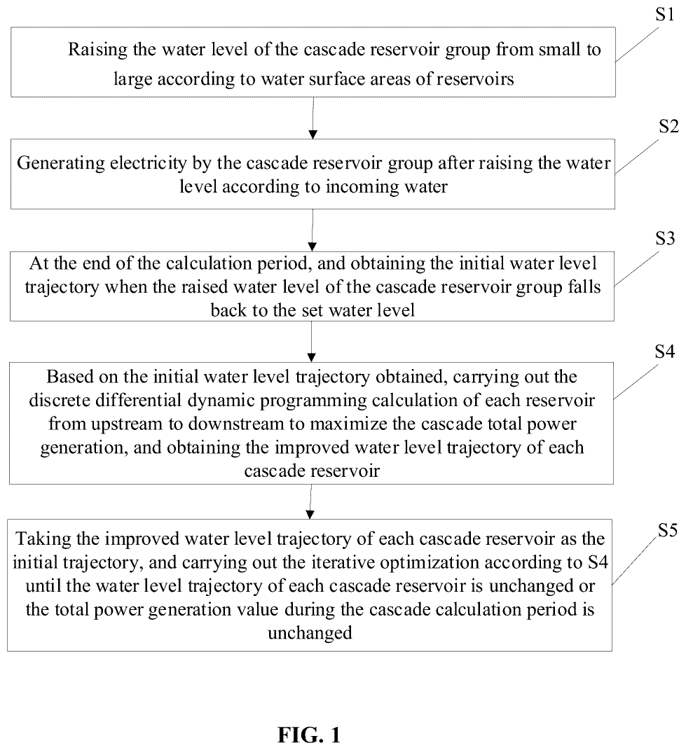

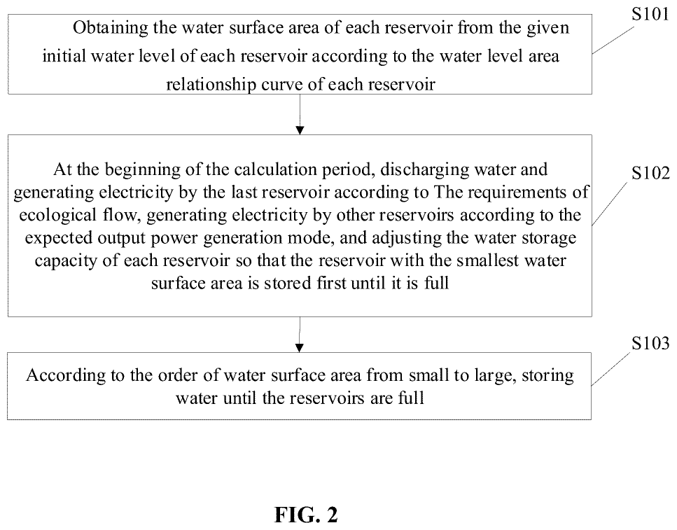

As shown in FIG. 1, a flow chart of the float-discrete differential dynamic programming successive approximation method for cascade reservoir group scheduling is proposed, comprising the following steps:
S1, the water levels of the cascade reservoir group are raised from small to large according to the water surface areas of reservoirs (as shown in FIG. 2);
S101, the water surface area of each reservoir is obtained from the given initial water level of each reservoir according to the water level area relationship curve of each reservoir;
S102, at the beginning of the calculation period, the last reservoir discharges the water and generates electricity according to the requirements of ecological flow, and other reservoirs generate electricity according to the expected output power generation mode (power generation as large as possible without wasting water), and the water storage capacity of each reservoir is adjusted so that the reservoir with the smallest water surface area is stored first until it is full;
S103, according to an order of water surface area from small to large, the water is stored until the reservoirs are full;
S2, the cascade reservoir group generates electricity after raising the water level according to the incoming water;

After the cascade reservoir group is filled, the water head of the cascade hydropower stations is maximized, at this time, the power generation efficiency of each cascade hydropower station is high according to the incoming water.

S3, at the end of the calculation period, and the initial water level trajectory is obtained when the raised water level of the cascade reservoir group falls back to the set water level;

S301, starting from the water level given at the end of the last period of the first reservoir and according to the expected output, the electricity is reversely generated according to the predicted natural inflow, and the initial water level of the period is calculated;

S302, based on the initial water level of the period calculated by S301, the electricity is generated reversely according to the expected output, and the initial water level of the previous period is calculated;

S303, S302 is repeated until the initial water level of a certain period exceeds the water level calculated by S1, at this time, the output value of this period is recalculated according to the water level calculated by S1, the water level change process, and the outflow process of the first hydropower station are obtained combined with the water level calculated by S1;

S304, S301-S303 are repeated for the cascade reservoirs from upstream to downstream until the calculation of the most downstream level reservoir is completed, and the initial water level trajectory of each cascade reservoir is obtained.

S4, based on the initial water level trajectory obtained, the discrete differential dynamic programming calculation of each reservoir is carried out from upstream to downstream to maximize the cascade total power generation, and the improved water level trajectory of each cascade reservoir is obtained.

A corridor is formed by taking 2-3 discrete points from the upper and lower water level values of the initial water level trajectory of the first reservoir at the end of each period (except the last period) according to the certain step length, and the initial water level trajectories of other reservoirs are fixed to maximize the cascade total power generation during the calculation period, the dynamic programming calculation in the corridor is carried to obtain the new water level trajectory, then, the corridors are re-selected based on the new water level trajectory for dynamic programming calculation until the new water level trajectory is stable, and then, the dynamic programming calculation is carried out after reducing a discrete step size until the discrete step size meets a preset accuracy and the water level trajectory is stable;
the calculations of the second and third reservoirs are carried out respectively according to the above steps until the calculation of the last reservoir is completed, and the improved water level trajectory of each cascade reservoir is obtained;
based on the improved water level trajectories of cascade reservoirs, the above process is repeated until the improved water level trajectories of cascade reservoirs are no longer changed.

Preferably, an maximum objective function of the cascade total power generation is as follows:

$$maxE = {\sum }_{i = 1}^{I} {\sum }_{t = 1}^{T} {N}_{it} Δ {T}_{t} = {\sum }_{i = 1}^{I} {\sum }_{t = 1}^{T} {K}_{i t} {Q}_{i t} {H}_{i t} Δ {T}_{t}$$

where E denotes the cascade power generation, kWh; I denotes the number of hydropower stations; i denotes the serial number of the hydropower stations, i∈[1, I]; T denotes the number of scheduling period; t denotes the serial number of the scheduling periods, t∈[1, T]; Kᵢₜ denotes the output coefficient of the i-th hydropower station in the t-th period; Nᵢₜ denotes the average output of the i-th hydropower station in the t-th period, kW; Qᵢₜ denotes the average power generation flow of the i-th hydropower station in the t-th period, m³/s; Hᵢₜ denotes the average power generation water head of the i-th hydropower station in the t-th period, m; ΔTₜ denotes the length of the t-th period, h.

The scheduling model of cascade hydropower stations to maximize the total power generation meets the following constraint:
reservoir water level constraint:

$${Z}_{min}^{i} ( t + 1 ) \leq {Z}_{i} ( t + 1 ) \leq {Z}_{max}^{i} ( t + 1 )$$

where Zᵢ(t+1) denotes the reservoir water level of the i-th reservoir at an end of the t-th period, m;

$${Z}_{min}^{i} ( t + 1 )$$

denotes the lower limit of the reservoir water level of the i-th reservoir at the end of the t-th period, m;

$${Z}_{max}^{i} ( t + 1 )$$

denotes the upper limit of the reservoir water level of the i-th reservoir at the end of the t-th period, m;
water balance constraint:

$${V}_{i} ( t + 1 ) - {V}_{i} ( t ) = ( {Q}_{in}^{i} ( t ) - {Q}_{out}^{i} ( t ) - {Q}_{loss}^{i} ( t ) ) Δ t$$

where Vᵢ(t+1) and Vᵢ(t) denote the storage capacities of the i-th reservoir at the end and the beginning of the t-th period;

$${Q}_{i n}^{i} ( t )$$

denotes the inflow of the i-th reservoir at the beginning of the t-th period;

$${Q}_{o u t}^{i} ( t )$$

denotes the outflow of the t-th reservoir at the beginning of the t-th period;

$${Q}_{l o s s}^{i} ( t )$$

denotes the loss flow of the i-th reservoir at the beginning of the t-th period;
output constraint of hydropower station:

$${P}_{min}^{i} ( t ) \leq {P}_{i} ( t ) \leq {P}_{max}^{i} ( t )$$

where Pᵢ(t) denotes the output of the i-th reservoir in the t-th period,

$${P}_{min}^{i} ( t )$$

denotes the lower limit of the output of the i-th reservoir in the t-th period;

$${P}_{max}^{i} ( t )$$

denotes the upper limit of the output of the i-th reservoir in the t-th period;
discharge flow constraint:

$${Q}_{min}^{i} ( t ) \leq {Q}_{o u t}^{i} ( t ) + {Q}_{l o s s}^{i} ( t ) \leq {Q}_{max}^{i} ( t )$$

where

$${Q}_{min}^{i} ( t )$$

denotes the lower limit or the outflow of the i-th reservoir in the t-th period, it is controlled by the ecological flow water demand or a power generation flow corresponding to a minimum output

$${Q}_{max}^{i} ( t )$$

denotes a maximum discharge of the i-th reservoir in the t-th period, it is controlled by a discharge capacity;

$${Q}_{i n}^{i + 1} ( t ) = {Q}_{o u t}^{i} ( t ) + {Q}_{loss}^{i} ( t ) + {Q}_{q j}^{i + 1} ( t )$$

where

$${Q}_{i n}^{i + 1} ( t )$$

denotes the inflow of the t-th period of the i+1-th reservoir, m³/s;

$${Q}_{q j}^{i + 1} ( t )$$

denotes the interval flow of the i-th reservoir and the i+1-th reservoir in the t-th period;
end water level constraint:

$${Z}_{i} ( T + 1 ) = {Z}_{i}^{e n d}$$

where Zᵢ(T+1) denotes the end water level of the i-th reservoir in the T-th period;

$${Z}_{i}^{e n d}$$

denotes the water level at the end of the calculation period of the i-th reservoir;
non-negative constraints: all variables are non-negative.

Therefore, the invention adopts a float-discrete differential dynamic programming successive approximation method for cascade reservoir group scheduling, which makes full use of the relationship between the output of cascade hydropower stations and the water head, reduces the invalid calculation workload, and improves the calculation efficiency.

Finally, it should be explained that the above embodiments are only used to explain the technical solution of the invention rather than restrict it, although the invention is described in detail concerning the better embodiment, ordinary technical personnel in this field should understand that they can still modify or replace the technical solution of the invention, and these modifications or equivalent substitutions cannot make the modified technical solution out of the spirit and scope of the technical solution of the invention.

What is claimed is:

1. A float-discrete differential dynamic programming successive approximation method for cascade reservoir group scheduling, comprising the following steps:
S1, raising a water level of a cascade reservoir group from small to large according to water surface areas of reservoirs;
S2, generating electricity by the cascade reservoir group after raising the water level according to incoming water;
S3, at an end of a calculation period, and obtaining an initial water level trajectory when a raised water level of the cascade reservoir group falls back to a set water level;
S4, based on the initial water level trajectory obtained, carrying out a discrete differential dynamic programming calculation of each reservoir from upstream to downstream to maximize a cascade total power generation, and obtaining an improved water level trajectory of each cascade reservoir;
S5, taking the improved water level trajectory of each cascade reservoir as an initial trajectory, and carrying out an iterative optimization according to S4 until the water level trajectory of each cascade reservoir is unchanged or a total power generation value during a cascade calculation period is unchanged.

2. The float-discrete differential dynamic programming successive approximation method for cascade reservoir group scheduling according to claim 1, wherein in S1, raising the water level of the cascade reservoir group from small to large according to the water surface areas of the reservoirs, the specific operation is as follows:
S101, obtaining the water surface area of each reservoir from a given initial water level of each reservoir according to a water level area relationship curve of each reservoir;
S102, at a beginning of the calculation period, discharging water and generating electricity by a last reservoir according to requirements of ecological flow, generating electricity by other reservoirs according to an expected output power generation mode, and adjusting a water storage capacity of each reservoir so that the reservoir with the smallest water surface area is stored first until it is full;
S103, according to an order of water surface area from small to large, storing water until the reservoirs are full.

3. The float-discrete differential dynamic programming successive approximation method for cascade reservoir group scheduling according to claim 2, wherein in S3, obtaining the initial water level trajectory when the raised water level of the cascade reservoir group falls back to the set water level, the specific operation is as follows:
S301, starting from the water level given at an end of a last period of a first reservoir and according to an expected output, reversely generating electricity according to a predicted natural inflow, and calculating an initial water level of the period;
S302, based on the initial water level of the period calculated by S301, reversely generating electricity according to the expected output, and calculating an initial water level of the previous period;
S303, repeating S302 until an initial water level of a certain period exceeds the water level calculated by S1, at this time, recalculating an output value of this period according to the water level calculated by S1, obtaining a water level change process of a first hydropower station combined with the water level calculated by S1;
S304, repeating S301-S303 for the cascade reservoirs from upstream to downstream until a calculation of a most downstream level reservoir is completed, and obtaining the initial water level trajectory of each cascade reservoir.

4. The float-discrete differential dynamic programming successive approximation method for cascade reservoir group scheduling according to claim 3, wherein in S4, based on the initial water level trajectory obtained, carrying out a discrete differential dynamic programming calculation of each reservoir from upstream to downstream, and obtaining an improved water level trajectory of each cascade reservoir, the specific operation is as follows:
forming a corridor by taking 2-3 discrete points from the upper and lower water level values of the initial water level trajectory of the first reservoir at the end of each period, and fixing initial water level trajectories of other reservoirs to maximize the cascade total power generation during the calculation period, carrying out the dynamic programming calculation in the corridor to obtain a new water level trajectory, then, re-selecting the corridors based on the new water level trajectory for dynamic programming calculation until the new water level trajectory is stable, and then, carrying out the dynamic programming calculation after reducing a discrete step size until the discrete step size meets a preset accuracy and the water level trajectory is stable;
carrying out calculations of the second and third reservoirs respectively according to the above steps until the calculation of the last reservoir is completed, and obtaining the improved water level trajectory of each cascade reservoir;
based on the improved water level trajectories of cascade reservoirs, repeating the above process until the improved water level trajectories of cascade reservoirs are no longer changed.

5. The float-discrete differential dynamic programming successive approximation method for cascade reservoir group scheduling according to claim 4, wherein an maximum objective function of the cascade total power generation is as follows:
$$max E = {\sum }_{i = 1}^{I} {\sum }_{t = 1}^{T} {N}_{i t} Δ {T}_{t} = {\sum }_{i = 1}^{I} {\sum }_{t = 1}^{T} {K}_{i t} {Q}_{i t} {H}_{i t} Δ {T}_{t}$$
where E denotes a cascade power generation, kWh; I denotes a number of hydropower stations; i denotes a serial number of the hydropower stations, i∈[1, I]; T denotes a number of scheduling periods; t denotes a serial number of the scheduling periods, t∈[1, T]; Kᵢₜ denotes an output coefficient of a i-th hydropower station in a t-th period; Nᵢₜ denotes an average output of the i-th hydropower station in the t-th period, kW; Qᵢₜ denotes an average power generation flow of the i-th hydropower station in the t-th period, m³/s; Hᵢₜ denotes an average power generation water head of the i-th hydropower station in the t-th period, m; ΔTₜ denotes a length of the t-th period, h.
